(19) United States
(12) Patent Application Publication
(10) Pub. No.: US 2025/0121335 A1
(43) Pub. Date: Apr. 17, 2025

(54) POROUS MEMBRANES HAVING AROMATIC FLUORINATED POLYMERS AND FORMATION THEREOF

(71) Applicant: ENTEGRIS, INC., Billerica, MA (US)

(72) Inventors: Aabid Ali Mir, Bedford, MA (US); Andrew Boudreau, Tewksbury, MA (US); Jad Ali Jaber, Westford, MA (US); Vinay Goel, Acton, MA (US)

(21) Appl. No.: 18/912,490

(22) Filed: Oct. 10, 2024

Related U.S. Application Data
(60) Provisional application No. 63/544,108, filed on Oct. 13, 2023.

(51) Int. Cl. B01D 71/44

(52) U.S. Cl. CPC B01D 71/44

(57) ABSTRACT

Polymers of the present disclosure include aromatic fluoropolymers or incorporation of fluorine groups into polymers, which can increase the chemical resistance and thermal stability of polymers. The combination of these properties provides for potential uses in membrane applications. Porous membranes obtained from disclosed polymers have improved resistance and chemical stability.

### CROSS-REFERENCE TO RELATED APPLICATIONS

The present application claims priority to and benefit of U.S. Provisional Patent Application No. 63/544,108, filed on Oct. 13, 2023. The entire contents of the above-referenced application are incorporated herein by reference.

### SUMMARY

Porous polymeric membranes are useful for removing contaminants from a variety of fluids. Factors for choosing polymers to use for a membrane include, but are not limited to, the cleanliness of polymers (e.g., it has minimal shedding of oligomers), the chemical compatibility with the specific fluid from which contaminants will be removed, and can be dissolved in solvents at room temperature so that it can be used in polymer phase separation membrane formation processes like NIPS (non-solvent induced phase separation) and VIPs (vapor-induced phase separation).

Current polymers used in porous polymeric membranes that can be used in polymer phase separation membrane formation processed include, but are not limited, polysulfone, polyethersulfone, polyarylsulfone, polyvinylidene fluoride, cellulosic polymers, polyacrylonitrile and nylon. Polymeric membranes prepared from these polymers, however, have severe chemical compatibility limitations when used in acidic (low pH), basic (high pH) and oxidizing environments. When exposed to such environments or used in removing contaminants from fluids that are acidic, basic, or oxidizing, these membranes may dissolve, degrade, crack or the polymeric chains may break and shed oligomers, thereby adding different contaminants in the fluid. This renders them either unsuitable or limited in useful life.

Thus, there is a need for polymers that do not suffer from these limitations but can be dissolved in common solvents and processed into porous membranes using polymers phase separation processes like NIPS and VIPS.

Polymers disclosed herein, also described as aromatic fluoropolymers (AFPs), address this need.

Membranes of the present disclosure are made from polymers that include aromatic fluoropolymers or incorporation of fluorine groups into polymers, which can increase the chemical resistance and thermal stability of polymers, and thus membranes including the same.

The combination of these properties provides for potential uses in membrane applications.

In some embodiments, a porous membrane disclosed herein comprises:
a polymer comprising one or more monomeric units having a formula according to formula (I):

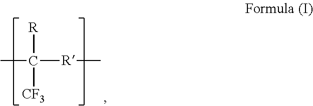

wherein R is an alkyl group, a substituted alkyl group, an aryl group, or a substituted aryl group, and wherein R′ is an alkyl group, a substituted alkyl group, an aryl group, or a substituted aryl group.

In some embodiments, a porous membrane disclosed herein comprises aromatic fluoropolymer, wherein the membrane has an initial bubble point in a range from 1 to 200 psi when measured using ethoxy-nonafluorobutane HFE 7200 at a temperature of about 22° C. and an IPA flow time in a range from 10 seconds/500 ml to 19,000 seconds/500 ml when measured at 14.2 psi.

In some embodiments, a porous membrane disclosed herein comprises aromatic fluoropolymer, wherein an initial bubble point of the membrane does not change by more than 20% when measuring the initial bubble point of the membrane before and after soaking the membrane in 96 wt % sulfuric acid for three days, wherein the initial bubble point of the membrane is measured using ethoxy-nonafluorobutane HFE 7200 at a temperature of about 22° C.

In some embodiments, disclosed herein is a method comprising: preparing a porous membrane with a polymer comprising one or more monomeric units having a formula according to formula (I):

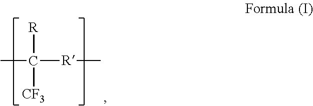

wherein R is an alkyl group, a substituted alkyl group, an aryl group or a substituted aryl group, and wherein R′ is an alkyl group, a substituted alkyl group, an aryl group, or a substituted aryl group.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 displays a reaction mechanism for synthesizing the polymer, in accordance with some embodiments.

FIG. 2 displays a reaction scheme for synthesizing polymers of Example 1.

FIG. 3 displays an exemplary filter, in accordance with some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

In this application, unless otherwise clear from context or otherwise explicitly stated, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; (iv) the terms “about” and “approximately” may be understood to permit standard variation as would be understood by those of ordinary skill in the relevant art; and (v) where ranges are provided, endpoints are included. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value). Furthermore, the term “based on” is not exclusive and allows for being based on additional factors not described, unless the context clearly dictates otherwise. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be: disposed directly between both of the two other structural elements such that the particular structural component is in direct contact with both of the two other structural elements; disposed directly next to only one of the two other structural elements such that the particular structural component is in direct contact with only one of the two other structural elements; disposed indirectly next to only one of the two other structural elements such that the particular structural component is not in direct contact with only one of the two other structural elements, and there is another element which juxtaposes the particular structural component and the one of the two other structural elements; disposed indirectly between both of the two other structural elements such that the particular structural component is not in direct contact with both of the two other structural elements, and other features can be disposed therebetween; or any combination(s) thereof.

As used herein “embedded” means that a first material is distributed throughout a second material.

As used herein, the term “alkyl” refers to a hydrocarbon chain radical having from 1 to 30 carbon atoms. The alkyl may be attached via a single bond. An alkyl having n carbon atoms may be designated as a “Cₙ alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is saturated (e.g., single bonds). In some embodiments, the alkyl is unsaturated (e.g., double bonds and/or triple bonds). In some embodiments, the alkyl is linear. In some embodiments, the alkyl is branched. In some embodiments, the alkyl is substituted. In some embodiments, the alkyl is unsubstituted. In some embodiments, the alkyl may comprise, consist of, or consist essentially of, or may be selected from the group consisting of, at least one of a C₁-C₁₂ alkyl, a C₁-C₁₁alkyl, a C₁-C₁₀ alkyl, a C₁-C₉ alkyl, a C₁-C₈ alkyl, a C₁-C₇ alkyl, a C₁-C₆ alkyl, a C₁-C₄ alkyl, a C₁-C₃ alkyl, or any combination thereof. In some embodiments, the alkyl may comprise, consist of, or consist essentially of, or may be selected from the group consisting of, at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, octyl, decyl, dodecyl, octadecyl, or any combination thereof.

As used herein, the term “aryl” refers to a monocyclic or polycyclic aromatic hydrocarbon compound. The term “aryl” refers to an aromatic ring comprising carbon and hydrogen atoms. The number of carbon atoms of the arene may be in a range of 5 carbon atoms to 100 carbon atoms. In some embodiments, the arene has 5 to 20 carbon atoms. For example, in some embodiments, the arene has 6 to 8 carbon atoms, 6 to 10 carbon atoms, 6 to 12 carbon atoms, 6 to 15 carbon atoms, or 6 to 20 carbon atoms. The term “monocyclic,” when used as a modifier, refers to an arene having a single aromatic ring structure. The term “polycyclic,” when used as a modifier, refers to an arene having more than one aromatic ring structure, which may be fused, bridged, spiro, or otherwise bonded ring structures. The term “alkyl-substituted arene” refers to an arene comprising one or more alkyl substituents. In some embodiments, the alkyl-substituted arene may comprise at least one of a monoalkylbenzene, a dialkylbenzene, a trialkylbenzene, a tetralkylbenzene, or any combination thereof. An arene may be referred to herein as Ar. Examples of aryls include, without limitation, phenyl, biphenyl, napthyl, and the like.

### Synthesis of Aromatic Fluorinated Polymers

In some aspects, the present disclosure relates to the synthesis of polymers including linear aromatic fluorinated polymers. The polymers can be synthesized by a one step, metal free super-acid catalyzed polyhydroxylation reaction of activated ketones (e.g., trifluoro acetones or a hexafluoro acetone) with non-activated multiring aromatic hydrocarbons (e.g., biphenyl). The polymerization can be carried out at room temperature in trifluorosulfonic acid (TFSA) or a mixture of TFSA and dichloromethane (DCM).

In some embodiments, preparing disclosed polymers includes adding a first compound to a second compound. In some embodiments, the first compound may be an activated ketone, including, but not limited to, a trifluoro acetone or a hexafluoro acetone. In some embodiments, the second compound may be a hydrocarbon, including, but not limited to biphenyl.

In some embodiments, R is an alkyl group, a substituted alkyl group, an aryl group, or a substituted aryl group.

In some embodiments, when R is the substituted alkyl group, the substituted alkyl group is a haloalkyl group, such as fluoro alkyl group, chloro alkyl group, iodo alkyl group, or bromo alkyl group. In some embodiments, when R is the substituted aryl group, the substituted aryl group is a halo aryl group, such as a fluoro aryl group, a chloro aryl group, an iodo aryl group, or a bromo aryl group. In some embodiments, when R′ is the substituted aryl group, the substituted aryl group is a substituted biphenyl, a substituted benzene, a substituted p-triphenyl, a substituted triphenyl, or a substituted quaterphenyl. In some embodiments, when R is the substituted alkyl group, the substituted alkyl group includes at least two substituents. In some embodiments, when R is the substituted aryl group, the substituted aryl group includes at least two substituents.

In some embodiments, R is a methyl group. In some embodiments, when R is a substituted alkyl group such as fluoro substituted methyl group, R is CH₂F, CHF₂ or CF₃.

In some embodiments, when R is an aryl group, the aryl group includes multiple phenyl groups, such as a biphenyl group, p-triphenyl group, triphenyl group, or quaterphenyl group. In some embodiments, at least one of the phenyl groups is substituted with at least one fluoro group.

In some embodiments, R′ is an alkyl group, substituted alkyl group, aryl group, or substituted aryl group. In some embodiments, when R′ is the substituted alkyl group, the substituted alkyl group is a haloalkyl group, such as a fluoro alkyl group, a chloro alkyl group, an iodo alkyl group, or a bromo alkyl group. In some embodiments, when R′ is the substituted aryl group, the substituted aryl group is a halo aryl group, such as a fluoro aryl group, a chloro aryl group, an iodo aryl group, or a bromo aryl group. In some embodiments, when R′ is the substituted aryl group, the substituted aryl group is a substituted biphenyl, a substituted benzene, a substituted p-triphenyl, a substituted triphenyl, or a substituted quaterphenyl. In some embodiments, when R′ is the substituted alkyl group or the substituted aryl group, the substituted alkyl group or the substituted aryl group includes at least two substituents.

In some embodiments, when R′ is an aryl group, the aryl group includes multiple phenyl groups, such as. a biphenyl group, p-triphenyl group, triphenyl group, or quaterphenyl group. In some embodiments, at least one of the phenyl groups is substituted with at least one fluoro group.

In some embodiments, disclosed polymers comprise a repeat unit having a formula according to formula (II):

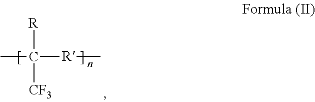

wherein R is an alkyl group, a substituted alkyl group, an aryl group, or a substituted aryl group, and wherein R′ is an alkyl group, a substituted alkyl group, an aryl group, or a substituted aryl group.

In some embodiments, disclosed polymers comprise a repeat unit having a formula according to formula (III):

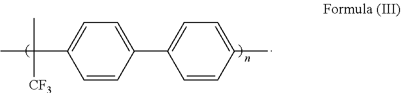

In some embodiments, polymers comprise a repeat unit having a formula according to formula (IV):

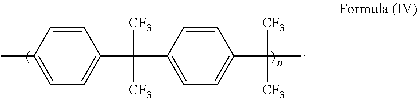

### Porous Polymeric Membranes

Porous polymeric membranes are useful for removing contaminants from a variety of fluids. Factors for choosing polymers to use for a membrane include, but are not limited to, the cleanliness of polymers (e.g., it has minimal shedding of oligomers), the chemical compatibility with the specific fluid from which contaminants will be removed, and can be dissolved in solvents at room temperature so that it can be used in polymer phase separation membrane formation processes like NIPS (non-solvent induced phase separation) and VIPs (vapor-induced phase separation).

Current polymers used in porous polymeric membranes that can be used in polymer phase separation membrane formation processed include, but are not limited, polysulfone, polyethersulfone, polyarylsulfone, polyvinylidene fluoride, cellulosic polymers, polyacrylonitrile and nylon. The polymeric membranes from these polymers, however, have severe chemical compatibility limitations when used in acidic (low pH), basic (high pH) and oxidizing environments. When exposed to such environments or used in removing contaminants from fluids that are acidic, basic, or oxidizing, these membranes may dissolve, degrade, crack or the polymeric chains may break and shed oligomers, thereby adding different contaminants in the fluid. This renders them either unsuitable or limited in useful life. Thus, there is a need for polymers that do not suffer from these limitations but can be dissolved in common solvents and processed into porous membranes using polymers phase separation processes like NIPS and VIPS. The polymers disclosed herein, aromatic fluoropolymers, address this need.

Membranes of the present disclosure are made from polymers that include aromatic fluoropolymers or incorporation of fluorine groups into polymers, which can increase the chemical resistance and thermal stability of polymers, and thus the membranes. The combination of these properties provides for potential uses in membrane applications. For example, membranes with polymers of the present disclosure may be used with solvents and demonstrate desirable chemical resistance in acids (such as concentrated sulfuric acid) and bases (such as sodium hydroxide). Furthermore, membranes with polymers of the present disclosure may also have desirable chemical resistance in a variety of solutions utilized throughout a semiconductor manufacturing process, for example Standard Clean 1 (SC1) solution employed in RCA clean.

In some embodiments, disclosed polymers can be isolated in methanol as white fibrous materials and can be used to cast flexible transparent plastic films. The isolated polymers can be used to form porous membranes, e.g., using immersion casting techniques. The isolated membranes can be porous and display chemical inertness and thermal stability.

Membranes of the present disclosure can be used, for example, in dilute wet etch and clean (WEC) chemistries. In contrast, existing membranes (e.g., membranes with polysulfones) can suffer from poor organic and acid chemical compatibility and also have inferior oxidative resistance because of carbon-oxygen (C—O) bonds, which can be liable to degradation. The synthesized polymers of the present disclosure can contain carbon-carbon (C—C) bonds and can design various functionality on polymers to achieve desired membrane morphology.

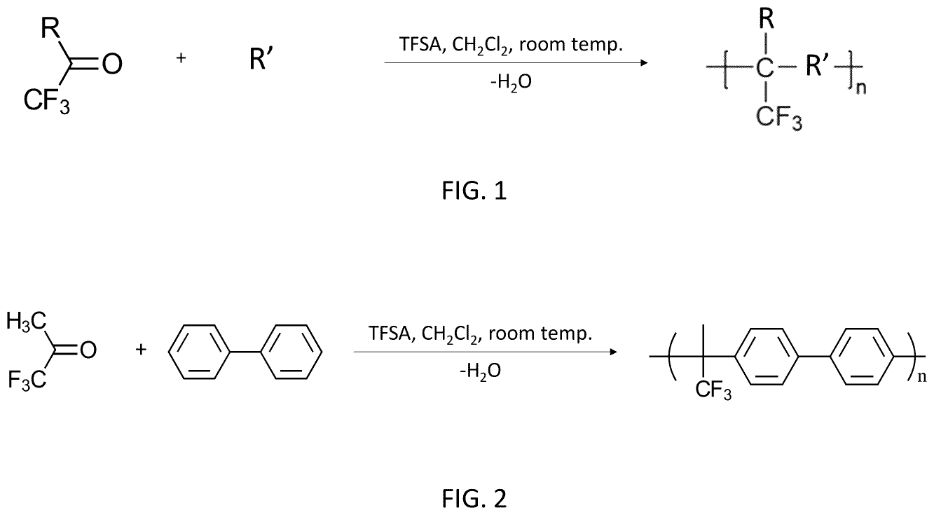

FIG. 1 displays a reaction mechanism for synthesizing the polymer, in accordance with some embodiments.

### Membrane Morphology

Membranes from the polymers disclosed herein can be formed into a number of different structures or morphologies.

In some embodiments, the membranes can be formed into symmetric morphologies where the pore size is very close to the same throughout the cross-section or thickness.

In some embodiments, the membranes can be formed into asymmetric (anisotropic) morphologies where the pore size can change across the membrane thickness.

In some embodiments for an asymmetric membrane, the pore size on one face and region of the membrane is larger than on the opposing face and region such that the pore sizes increase through the cross-section from one face or region to the other.

In some embodiments for an asymmetric membrane, asymmetric structures can exist where the pore size on the opposing faces (and regions) of the membrane are larger while a central region of the membrane has a smaller pore size than either of the faces (e.g., an hourglass pore size profile), as described for example in UK Publication No. GB 2199786 A.

In some embodiments, the membranes can be formed as composite membranes. In this case these membranes are formed as thin layers on top of pre-formed porous membranes, as described for example in EP Patent. No. 0772489B1. In some embodiments, membranes can also be co-cast or formed as multi-layer membranes. In this case, different casting solutions are applied, either simultaneously, or in a staggered manner to the formation process resulting in integral membranes with each layer having a different pore size or morphology, as described for example in U.S. Pat. No. 10,751,669. The above variations can be accomplished in membranes disclosed herein made as flat sheets or as hollow fibers.

In some embodiments, the porous membranes can be formed as flat sheet membranes or hollow fiber membranes and can be packaged into filter cartridges.

The present disclosure includes porous membrane constructions that can exhibit useful or advantageous filtering performance properties, including high flux combined with relatively high bubble point (small pore size) and good retention, as well as chemical stability in acids and bases. The performance compares well or shows substantial improvement relative to previous and current commercial membrane products.

### Membrane Thicknesses

Disclosed membranes can have any thickness useful for its intended application. For example, disclosed membranes can have a thickness in a range of about 1 μm to about 1000 μm, about 1 μm to about 900 μm, about 1 μm to about 800 μm, about 1 μm to about 700 μm, about 1 μm to about 600 μm, about 1 μm to about 500 μm, about 1 μm to about 400 μm, about 1 μm to about 300 μm, about 1 μm to about 200 μm, about 1 μm to about 100 μm, or any range or subrange therein. For example, in some embodiments, disclosed membranes can have a thickness in a range of about 3 μm to about 200 μm. In some embodiments disclosed membranes can have a thickness in a range of about 5 μm to about 150 μm. In some embodiments, disclosed membranes can have a thickness in a range of about 10 μm to about 100 μm. In some embodiments, disclosed membranes can have a thickness in a range about 15 μm to about 80 μm.

Any of a variety of characterization techniques known in the art may be used to measure membrane thickness, for example scanning electron microscopy (SEM), atomic force microscopy (AFM), etc.

### Membrane Characteristics

In some embodiments, membranes with polymers of the present disclosure can be described by physical features that include pore size, bubble point, and porosity. A membrane that is used in a filter may have any pore size that will allow the membrane to be effective for performing as a filter, e.g., as described herein, including pores of a size (average pore size) considered as a microporous filter membrane or an ultrafilter membrane. Examples of useful porous membranes can have an average pore size in a range from about 0.001 μm to about 10 μm with the pore size to be selected based on one or more factors that include: the particle size or type of impurity to be removed, pressure and pressure drop requirements, and viscosity requirements of a liquid being processed by the membrane. Pore size is often reported as average pore size of a porous material, which can be measured by known techniques such as by Mercury Porosimetry (MP), Scanning Electron Microscopy (SEM), Liquid Displacement (LLDP), or Atomic Force Microscopy (AFM).

Bubble point is also a known feature of a porous membrane. By a bubble point test method, a sample of porous membrane is immersed in and wetted with a liquid having a known surface tension, and a gas pressure is applied to one side of the sample. The gas pressure is gradually increased.

The minimum pressure at which the gas flows through the sample is called an initial bubble point. The initial bubble point of a porous material as reported herein, is determined as follows: a sample of the porous material is immersed in and wetted with ethoxy-nonafluorobutane HFE 7200 (available from The 3M Company, St. Paul, MN) at a temperature of 20-25° C. (e.g., 22° C.). A gas pressure is applied to one side of the sample by using compressed air and the gas pressure is gradually increased. All initial bubble point values provided herein are measured using this procedure.

In some embodiments, the relationship between bubble point and pore size is expressed by the Washburn equation, or a modified version thereof (e.g., with pore size corrections) to account for different pore geometries. In some embodiments, the bubble point pressure relates to the retention capability of the membrane. Additional details for bubble point, among other things, are available in U.S. Pat. No. 4,828,772, which is incorporated by reference herein in its entirety.

Examples of useful initial bubble point values of a porous membrane according to the present disclosure, measured using the procedure described above, can be in a range from about 1 to about 200 psi, about 1 to about 150 psi, about 1 to about 100 psi, about 10 to about 200 psi, about 10 to about 150 psi, about 10 to about 100 psi, about 10 to about 40 psi, about 20 to about 200 psi, about 20 to about 150 psi, about 20 to about 100 psi, about 40 to about 200 psi, about 40 to about 150 psi, about 40 to about 100 psi, about 60 to about 200 psi, about 60 to about 150 psi, about 60 to about 100 psi, about 80 to about 200 psi, about 80 to about 150 psi, about 100 to about 200 psi, about 100 to about 150 psi, about 150 to about 200 psi, or any and all ranges therebetween.

A porous membrane as described may have any porosity that will allow the porous membrane to be effective as described herein. In some embodiments, membranes can have a relatively high porosity, for example a porosity of at least 60, 70 or 80 percent. As used herein, and in the art of porous bodies, a “porosity” of a porous body (also sometimes referred to as void fraction) is a measure of the void (i.e., “empty”) space in the body as a percent of the total volume of the body and is calculated as a fraction of the volume of voids of the body over the total volume of the body. A body that has zero percent porosity is completely solid.

Membrane isopropanol (IPA) flow times as reported herein can be determined by measuring the time it takes for 500 ml of isopropyl alcohol (IPA) fluid to pass through a membrane with a 47 mm membrane disc with an effective surface area of 13.8 cm², at 14.2 psi, and at a temperature of 21° C. In some embodiments, the flow time is in a range of about 10 seconds/500 ml to about 19,000 seconds/500 ml, about 10 seconds/500 ml to about 5,000 seconds/500 ml, about 10 seconds/500 ml to about 1,000 seconds/500 ml, about 10 seconds/500 ml to about 800 seconds/500 ml, about 10 seconds/500 ml to about 500 seconds/500 ml, about 100 seconds/500 ml to about 10,000 seconds/500 ml, about 100 seconds/500 ml to about 5,000 seconds/500 ml, about 100 seconds/500 ml to about 1,000 seconds/500 ml, about 100 seconds/500 ml to about 800 seconds/500 ml, about 100 seconds/500 ml to about 500 seconds/500 ml, about 500 seconds/500 ml to about 10,000 seconds/500 ml, about 500 seconds/500 ml to about 5,000 seconds/500 ml, about 500 seconds/500 ml to about 1,000 seconds/500 ml, about 500 seconds/500 ml to about 800 seconds/500 ml, about 845 seconds/500 ml to about 10,000 seconds/500 ml, about 845 seconds/500 ml to about 5,000 seconds/500 ml, about 845 seconds/500 ml to about 1,665 seconds/500 ml, about 845 seconds/500 ml to about 1000 seconds/500 ml, about 1,000 seconds/500 ml to about 10,000 seconds/500 ml, about 1,000 seconds/500 ml to about 5,000 seconds/500 ml, about 20 seconds/500 ml to about 2,500 seconds/500 ml, or all ranges and subranges therebetween.

In some embodiments, the present disclosure includes a porous membrane having an aromatic fluoropolymer, wherein the membrane has an initial bubble point between 1 to 200 psi and an IPA flow time in a range from 10 seconds/500 ml to 19,000 seconds/500 ml. In some embodiments, the aromatic fluoropolymers comprise one or more monomeric units having a formula (I),

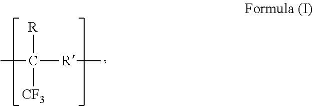

where R is an alkyl group, a substituted alkyl group, an aryl group or a substitute aryl group, and R′ is an alkyl group, a substituted alkyl group, an aryl group, or a substituted aryl group.

In some embodiments, the porous membrane includes aromatic fluoropolymers having initial bubble point between 10-20 psi and IPA flow time between 200-400 seconds/500 ml. In some embodiments, the porous membrane includes aromatic fluoropolymers having initial bubble point between 20-40 psi and IPA flow time between 400-1000 seconds/500 ml. In some embodiments, the porous membrane includes aromatic fluoropolymers having initial bubble point between 40-60 psi and the IPA flow times between 1000-2000 seconds/500 ml. In some embodiments, the porous membrane includes aromatic fluoropolymers having initial bubble point between 60-80 psi and IPA flow time between 2000-3000 seconds/500 ml. In some embodiments, the porous membrane includes aromatic fluoropolymers having initial bubble point between 80-100 psi and IPA flow time between 3000-4000 seconds/500 ml. In some embodiments, the porous membrane includes aromatic fluoropolymers having initial bubble point between 100-120 psi and IPA flow time between 4000-5000 seconds/500 ml.

In some embodiments, the membranes disclosed herein have chemical stability and resistance to acids, such as concentrated sulfuric acid. In some embodiments, the chemical stability in concentrated sulfuric acid can be evidenced wherein an initial bubble point of the membrane changes by less than 20%, less than 15% or less than 10% when measuring the initial bubble point of the membrane before and after soaking the membrane in 96 wt % sulfuric acid for three days, wherein the initial bubble point of the membrane is measured using ethoxy-nonafluorobutane HFE 7200 at a temperature of about 22° C. In some embodiments, the chemical stability in concentrated sulfuric acid can in addition, or alternatively, be evidenced by the membrane, upon visual inspection, not changing color and/or dissolving when soaked in 96 wt % sulfuric acid for three days upon visual inspection.

In some embodiments, the membranes disclosed herein have chemical stability and resistance to bases, such as sodium hydroxide. In some embodiments, the chemical stability in sodium hydroxide can be evidenced by the membrane, upon visual inspection, not changing color and/or dissolving when soaked in 0.04 wt % sodium hydroxide for 1 day.

In some embodiments, polymers of the present disclosure do not include a polyaryl ether, a polysulfone, or a polytetrafluoroethane. In some embodiments, polymers of the present disclosure do not include an ether linkage.

In some embodiments, polymers comprise only carbon-carbon bonds in a backbone of polymers of the present disclosure.

In some embodiments, polymers of the present disclosure include an aromatic fluoropolymer. In some embodiments, polymers of the present disclosure is linear. In some embodiments, polymers of the present disclosure is a linear aromatic fluoropolymer.

### Functionalized Porous Polymeric Membranes

Membranes from the polymers disclosed herein can be functionalized using a number of different techniques.

For example, in some embodiments, the porous membrane can be a coated porous membrane where the porous membrane (e.g., a porous polymeric filter layer) has a polymer film coating at one or more surfaces of the porous membrane, as described for example in U.S. Pat. No. 11,413,586. In some embodiments, polymer film coatings are film coatings that includes crosslinked polymer. In some embodiments, polymer film coatings can be porous or non-porous.

The film may be continuous over an entire portion of a surface or surfaces of the porous membrane (e.g., a porous polymeric film layer), or may be semi-continuous, meaning that the film may be interrupted but may cover a substantial portion of the porous membrane.

In some embodiments, the porous membrane can have a coating of one or more polymerized monomers with a positive, negative, or neutral charge in an organic liquid, and combinations thereof, as described for example in U.S. Publication No. 2022/0134287. The coating can include an organic backbone formed from the polymerized monomers. The coating can include a crosslinker and a monomer or a co-polymer. In some embodiments, the plurality of polymerized monomers may differ from each other or may be the same with respect to various characteristic. Polymerization and cross-linking of the polymerizable monomer onto the porous membrane substrate is effected so at least a portion and up to the entire surface of the porous membrane, including the inner pore surfaces of the porous membrane, is modified with a cross-linked polymer. In some embodiments, the coating can cover as much of the surface of the porous membrane as desired, from greater than 0% to 100%, with cross-linked polymer composition.

In some embodiments, the porous membrane can use grafting to modify the porous membrane and bond the polymerized monomer, co-polymer, cross-linker or a combination of these directly to the porous membrane material, as described for example in U.S. Publication No. 2022/0032282. In some embodiments, a combination of techniques can be used on the porous membrane such as a membrane having a portion that is cross-linked and a portion of that is grafted. Embodiments also encompass cross-linking a grafted portion. The cross-linking and grafting techniques encompass coating as much of the surface of the porous membrane as desired from greater than 0% to 100%.

In some embodiments, the present disclosure relates to a porous membrane containing blends of polymer with formula (IV) and other polymers or copolymers, as described for example in EP 1149625 B1. In some embodiments, the present disclosure relates to membranes where the other polymers or copolymers can have a fluorinated or nonfluorinated organic backbone with a positive, negative or neutral charge, and combinations thereof.

In some embodiments, the functionalized membranes of this disclosure can be used to remove ions, organics and metal contaminants from organic and aqueous liquids.

### Filters and Filter Devices

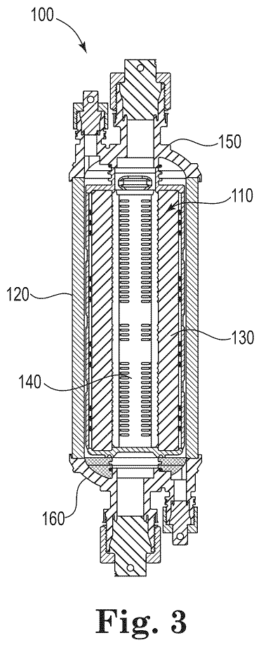

In some embodiments, a filter includes a membrane of the present disclosure. To perform a filtration function, a filter can include a filter membrane which is responsible for removing unwanted material from a fluid which passes through the filter membrane. The filter membrane may, as required, be in the form of a flat sheet, which may be wound (e.g., spirally), flat, pleated, or disk-shaped. The filter membrane may alternatively be in the form of a hollow fiber. The filter membrane can be contained within a housing or otherwise supported so that fluid that is being filtered enters through a filter inlet and is required to pass through the filter membrane before passing through a filter outlet. An exemplary filter 100 is shown in FIG. 3 having a filter cartridge 110 disposed in a housing 120. A membrane 130 is disposed in the filter cartridge and arranged around a core 140 that provides support to membrane 130. Endcaps 150 and 160 may be attached to opposite ends of housing 120 and provides openings for the fluid that will be filtered and/or purified to pass in and out of filter 100.

A filter membrane can be constructed of a porous structure that has average pore sizes that can be selected based on the use of the filter, i.e., the type of filtration performed by the filter. Typical pore sizes are in the micron or sub-micron range, such as from about 0.001 micron to about 10 μm. Membranes with average pore size of from about 0.001 to about 0.1 micron are sometimes classified as ultrafilter membranes. Membranes with pore sizes between about 0.1 and 10 μm are sometimes referred to as microporous membranes.

A membrane having micron or sub-micron-range pore sizes can be effective to remove an unwanted material (i.e., an impurity) from a fluid flow either by a sieving mechanism or a non-sieving mechanism, or by both. A sieving mechanism is a mode of filtration by which a particle is removed from a flow of liquid by mechanical retention of the particle at a surface of a membrane, which acts to mechanically interfere with the movement of the particle and retain the particle within the filter, mechanically preventing flow of the particle through the filter. Sometimes, the particle can be larger than pores of the filter. A “non-sieving” filtration mechanism is a mode of filtration by which a membrane retains a suspended particle or dissolved material contained in flow of fluid through the membrane in a manner that is not exclusively mechanical, e.g., that includes an electrostatic mechanism by which a particulate or dissolved impurity is electrostatically attracted to and retained at a filter surface and removed from the fluid flow; the particle may be dissolved, or may be solid with a particle size that is smaller than pores of the filter medium.

The filter comprising the membrane can be in any desired form suitable for a filtering application. Material that forms the filter can be a structural component of a filter itself and that provides the filter with a desired architecture. The membrane can be of any desired shape or configuration.

The porous membranes of the present disclosure can be used in a variety of applications or uses. In some embodiments, the porous membranes can be used with any type of industrial or life sciences applications that requires a high purity liquid material as an input. In many life science applications, porous membranes are used to remove biological contaminants like bacteria, viruses, endotoxins, etc. In many industrial applications, porous membranes are used to remove particulate matter. Semiconductor processes require ultra clean fluids to prevent defects. The membranes disclosed herein can be used to remove trace levels of contaminants like particles, metal ions, aggregates, etc. The uses of the membranes disclosed herein are not limited to the above mentioned applications. Any filtration or purification application that requires, clean, inert, stable, and high filtration efficiency can benefit from the use of the membranes disclosed herein. Additional non-limiting examples of such applications include processes of preparing microelectronic or semiconductor devices, for example in the filtration or purification of liquid process materials used in wet etch and clean or photolithography processes; diagnostic applications; inkjet application; filtering fluids for the pharmaceutical industry; metal removal; production of ultrapure water; treatment of industrial and surface waters; filtering fluids for medical applications (for example intravenous application); filtering biological fluids such as blood (for example for virus removal); filtering fluids for the food and beverage industry; beer filtration; clarification; filtering antibody-containing fluids and/or protein-containing fluids; filtering nucleic acid-containing fluids; cell harvesting; filtering cell culture fluids; and/or venting applications.

Examples of contaminants present in a process liquid or solvent used for preparing microelectronic or semiconductor devices may include metal ions dissolved in the liquid, solid particulates suspended in the liquid, and gelled or coagulated materials present in the liquid.

As discussed herein, the porous membranes can be a single layer or may be a multilayer, e.g., being combined with another filter material to form a composite filter membrane. In either case, the membrane can be useful to remove a dissolved or suspended contaminant or impurity from a liquid that is caused to flow through the membrane, either by a sieving mechanism or a non-sieving mechanism, as well as by both a combined non-sieving and a sieving mechanism.

### Membrane Preparation

In some embodiments, the present disclosure relates to a method of preparing a porous membrane with a polymer of the present disclosure. For example, in some embodiments, the present disclosure relates to a method of preparing a porous membrane with a polymer of the present disclosure, e.g., a polymer comprising one or more monomeric units having a formula of:

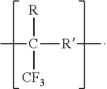

In some embodiments, methods of preparing disclosed porous membranes includes steps of: preparing a solution of a disclosed aromatic fluoropolymer and a suitable solvent; casting the prepared solution onto a substrate (e.g., a glass substrate); and immersing the cast solution to form a porous membrane.

Any of a variety of solvents useful for preparing a solution of a disclosed polymer may be used. For example, in some embodiments suitable solvents include, N-methyl-2-pyrrolidine (NMP), isopropyl alcohol (IPA), or a combination of both.

Any of a variety of casting methods may be used for casting solutions of disclosed polymers onto substrates to prepare membranes of the present disclosure. For example, in some embodiments, casting can be performed by a film applicator, such as a TQC Automatic Film Applicator. In some embodiments, porous membrane thickness can be controlled by varying sizes of film applicator components (e.g., blades or knives on a film applicator).

Any of a variety of substrates may be used for the purpose of casting a solution of disclosed polymers during preparation of disclosed porous membranes. For example, in some embodiments a substrate may be a glass substrate. Additionally or alternatively, a substrate may be a porous polymeric substrate. By casting onto a porous polymeric substrate, a composite membrane having a first layer of a disclosed polymer and a second layer including the porous polymeric substrate may be formed. Any of a variety of porous polymeric substrates may be employed. For example, in some embodiments, a porous polymeric substrate may include a fluorinated polymer, such as polytetrafluoroethylene (PTFE).

In some embodiments, immersing includes immersing a cast solution of disclosed polymers in a liquid. In some embodiments, a liquid may be any of a variety of liquids suitable to provide for porous membrane. For example, a cast solution of a disclosed polymer may be immersed in a bath of water (e.g., held at room temperature) to form a porous membrane sheet (e.g., a membrane sheet).

### Examples

### Example 1: Synthesis of Exemplary Polymer A

The present example demonstrates synthesis of an exemplary polymer (“Polymer A”).

A solution of biphenyl (25.0 g, 162 mmol) in 60 ml of dichloromethane was added via addition funnel to a reactor (2 L) equipped with an overhead mechanical stirrer. The solution was stirred at 400 revolutions per minute (RPM). Then, trifluoromethanesulfonic acid (TFSA) (48.6 g, 324 mmol) was added via dosing pump in 60 mL of dichloromethane over 20 min. After that, the solution was cooled at −20° C. Subsequently, trifluoroacetone (25.1 g, 224 mmol) was added all at once using a syringe. The reaction mixture was gradually warmed up to 30° C. in 1 h. The reaction mixture was stirred at 30° C. for 8 h. Then, the reaction mixture was cooled down to 2° C. and a solution of potassium carbonate (26.9 g, 194.5 mmol) in 27 mL of deionized water was added dropwise to the reaction mixture for about 10 minutes using a syringe pump. The resulting dark-brown suspension was poured slowly into 600 mL of methanol to isolate the exemplary polymer. The white precipitate was filtered, washed with 50 mL of methanol and dried overnight in a convection oven at 80° C. A white fibrous polymer was obtained (38.5 g, 95.6% yield, Mw=55 kDa, PDI=2.01). The polymer was characterized by ¹H & ¹⁹F-NMR.

### Example 2: Preparation of Membranes Using Polymer A

The present example demonstrates the preparation of an exemplary porous membrane including an exemplary polymer synthesized as demonstrated in Example 1.

Polymer A of Example 1 was dried overnight at 60° C. to remove any residual solvent and water before the membrane preparation. Membrane casting formulations were made according to exemplary formulations described in Table 1. The exemplary formulations included Polymer A prepared as demonstrated in Example 1, N-methyl-2-pyrrolidine (NMP) and isopropyl alcohol (IPA). The membrane casting formulation was metered through a controlled slot between the casting knife on the glass plate of the TQC Automatic Film Applicator (available from TQC Sheen B.V., Nieuwerkerk aan den Ijssel, Netherlands) and the membrane sheets were cast at a speed of 1 inch/second. The cast membrane sheets were then immersed into a water bath held at room temperature. The thickness of the membrane was controlled by using the different sizes knife. In the present example, membranes had a thickness of 75 μm. The porous membranes were washed in water for a couple of hours. IPA flow time and initial bubble point were tested using the methods described above. The results are shown in the below Table 1. As can be seen increasing the weight percentage of polymer increases the initial bubble point and the IPA flow time.

TABLE 1
Example 2 Membrane Casting Formulations and Membrane Performance

| Formulation | | Mw | Wt % | NMP | IPA | Initial BP | IPA-FT |
|---|---|---|---|---|---|---|---|
| ID | Polymer | (kDa) | Polymer | (wt %) | (wt %) | (psi) | (sec/500 ml) |
| 1 | Polymer A | 55 | 10 | 67 | 22 | 35 | 1000 |
| 2 | Polymer A | 55 | 15 | 67 | 22 | 43 | 2180 |
| 3 | Polymer A | 55 | 18 | 67 | 22 | 76 | 5480 |

### Example 3: Synthesis of Exemplary Polymer B

The present example demonstrates synthesis of an exemplary polymer (“Polymer B”).

Polymer B was synthesized according to the following procedure. A three-neck round bottom flask equipped with a mechanical stirrer, over-head condenser was charged with trifluoroacetone (6.5 ml, 72.8 mmol), biphenyl (9.2 g, 59.54 mmol), and 60 ml of dichloromethane. The solution was cooled down to 0° C. using ice. Trifluoromethanesulfonic acid (TFSA) (25 mL, 291 mmole) was added in one portion using a dropping funnel, and the reaction mixture was stirred for one-hour at this temperature. The temperature was then gradually raised to room temperature, and the reaction mixture was stirred at this temperature for three-hours. After the reaction was complete, it was cooled down to 2° C. and neutralized with a saturated solution of potassium carbonate. The resulting dark-brown solution was then poured slowly into methanol to isolate the polymer. The precipitated white solid was filtered, washed with methanol (300 mL), and dried overnight in an oven at 80° C. to yield 14.12 grams of white fibrous polymer with 95.5% yield. The polymer was characterized by ¹H-NMR and gel permeation chromatography (GPC) for molecular weight. A white fibrous polymer was obtained (Mw=154 kDa, PDI=2.72). The polymer was characterized by ¹H & ¹⁹F-NMR.

### Example 4: Preparation of Membranes Using Polymer B Prepared According to Example 3

A membrane casting formulation was prepared according to an exemplary formulation described in Table 2. The formulation included Polymer B prepared as demonstrated in Example 3, NMP and IPA. The membrane casting formulation was poured on the glass surface of the TQC Automatic Film Applicator (available from TQC Sheen B.V., Nieuwerkerk aan den Ijssel, Netherlands), and the membrane sheets were cast at a speed of 1 inch/second. The cast membrane sheets were then immersed into a water bath held at room temperature. In the present example, membranes had a thickness of 75 μm. The porous membranes were washed in water for couple of hours. Membrane performance (including IPA flow time and initial bubble point) was tested, and the results are shown in the below Table 2.

TABLE 2
Example 3 Membrane Casting Formulations and Membrane Performance

| Formulation | | | Wt % | NMP | IPA | Initial | IPA-FT |
|---|---|---|---|---|---|---|---|
| ID | Polymer | Mw (kDa) | Polymer | (wt %) | (wt %) | BP (psi) | (sec/500 ml) |
| 4 | Polymer B | 154 | 10 | 67.50 | 22.50 | 90 | 1500 |

### Example 5: Synthesis of Exemplary Polymer C

The present example demonstrates synthesis of an exemplary polymer (“Polymer C”) in accordance with the present disclosure.

To a reactor (2 L) equipped with an overhead mechanical stirrer a solution of biphenyl (18.4 g, 119 mmol) in 60 ml of dichloromethane was added via addition funnel. The solution was stirred at 400 revolutions per minute (RPM). Then, trifluoromethanesulfonic acid (TFSA) (87.3 g, 582 mmol) was added via dosing pump with 60 mL of dichloromethane over 20 min. After that, the solution was cooled down to −20° C. Subsequently, trifluoroacetone (18.4 g, 164 mmol) was added all at once using a syringe. Then, the reaction mixture was gradually warmed up to 30° C. in 1 h. The reaction was then stirred at 30° C. for 4 h. The reaction mixture was cooled down to 2° C. and a solution of potassium carbonate (48.3 g, 349 mmol) in 50 mL of deionized water was added dropwise to the reaction mixture for about 10 minutes using a syringe pump. The resulting dark-brown suspension was poured slowly into 600 mL of methanol to isolate the polymer. The white precipitate was filtered, washed with 50 mL of methanol and dried overnight in a convection oven at 80° C. A white fibrous polymer was obtained (27.0 g, 91.52% yield, Mw=992.7 kDa, PDI=3.92).

### Example 6: Preparation of Membranes Using Polymer C

The present example demonstrates the preparation of an exemplary porous membrane including an exemplary polymer synthesized as demonstrated in Example 5.

Exemplary Polymer C was dried overnight at 60° C. to remove any residual solvent and water before the membrane preparation. A membrane casting formulation using was prepared according to an exemplary formulation described in Tale 3. The exemplary formulation included Polymer C prepared as demonstrated in Example 5, NMP and IPA. The membrane casting formulation was poured on the glass surface of the TQC Automatic Film Applicator, and membrane sheets were cast at a speed of 1 inch/second. The cast membrane sheets were immersed into a water bath held at room temperature. In the present example, membranes had a thickness of 75 μm. The membranes were washed in water for a couple of hours and membrane performance including IPA flow time, and initial bubble point was tested according to methods described herein, and the results are shown in the below Table 3.

TABLE 3
Example 6 Membrane Casting Formulation
and Membrane Performance

| | | | | | Initial | |
|---|---|---|---|---|---|---|
| | Mw | wt % | NMP | IPA | BP | IPA-FT |
| Polymer | (kDa) | Polymer | (wt %) | (wt %) | (psi) | (sec/500 ml) |
| Polymer 3 | 992.7 | 5 | 67 | 22 | 47 | 585 |

### Example 7: Chemical Resistance of Membranes Including Exemplary Polymers in 96 wt % Sulfuric Acid

The chemical stability in concentrated sulfuric acid of 47 mm membrane disc made from the membrane made according to Example 4 was tested. The membranes were first pre-wet with HFE-7200 solvent and then initial bubble points (BP) in HFE-7200 solvent were measured using the method described above. The same membrane disc was exchanged in DIW and soaked in 96 wt % sulfuric acid for 3 under static conditions at room temperature. After soaking, the membrane disc was removed and washed in DIW thoroughly to remove any traces of acid, pre-wetted in IPA to remove any residual water and exchanged into HFE-7200 solvent for about 15 minutes using a shaker. The initial bubble point of the membrane before and after soaking were measured using the method described above, and the results are reported in the table below. The initial bubble point increase by only about 10.6% after the three-day soak compared to before the soak. The membranes were resistant and stable in sulfuric acid as evidenced by the initial bubble point changing by less than 20% when comparing the post-soak initial bubble point to the pre-soak bubble point. Upon visual inspection after soaking, the membrane did not change color and did not dissolve, which were other indications of chemical stability in sulfuric acid.

TABLE 4
Initial Bubble Point Before and After
Soaking in 96 wt % Sulfuric Acid

| Condition | Initial Bubble Point (psi) |
|---|---|
| Before Soak | 66 |
| After 3-Day soak | 73 |

### Example 8: Chemical Resistance of Membranes Including Exemplary Polymers in Sodium Hydroxide

The chemical stability in sodium hydroxide of a 47 mm membrane disc made from the membrane prepared as described in Example 2 was tested and compared to polyvinyl difluoride (PVDF) membrane. The membranes were soaked in sodium hydroxide for 24 hours at room temperature. The PVDF membrane immediately changes in color to black, indicating that it was not chemically stable in sodium hydroxide. The membrane made according to Example 2 did not change color or dissolve upon visual inspection, indicating that the membrane made according to Example 2 was chemically stable in sodium hydroxide.

### Example 9: Chemical Resistance in SC1

The chemical resistance of the membranes was tested in SC1 chemistry according to the following procedure. A membrane sheet comprising a disclosed polymer was first pre-wet with IPA and then exchanged with DIW. It was then soaked for 7-days in the SC1 chemistry which was prepared freshly by mixing 5 volumes of DIW with 1 volumes of ammonium hydroxide and 1 volume of 30% H₂O₂. After soaking, the membrane sheet was removed and washed in DIW thoroughly to remove any traces of acid. The membranes were then tested for flow times and compared with the flow times of membranes prior to being soaked in SC1. The peroxide-soaked membranes were also tested for brittleness as measured by Instron and the data is reported in elongation at break (%) in the table 1 below. No significant change was observed in strain at break on the peroxide-soaked membranes.

TABLE 5
SC1 Solution Composition

| SC1 | Volume (%) | Vol (mL) |
|---|---|---|
| 5 | 5 vol. of DIW | 357.2 |
| 1 | 1 vol. 29% NH₄OH | 71.4 |
| 1 | 1 vol. 30% H₂O₂ | 71.4 |
| | | 500 |

TABLE 6
DIW Flow Time of Exemplary Membranes after Soaking in SC1
DIW Flow Time (sec/500 mL)

| Before Soaking in SC1 | 7-day Soak in SC1 | % Change |
|---|---|---|
| 407 | 364 | 11.8 |

TABLE 7
Stain at Break of Exemplary Membranes after Soaking in H₂O₂

| | Strain at Break (%) |
|---|---|
| Before Soaking | 15% |
| After Soaking | 16% |

### Example 10: Chemical Resistance of Composite Membranes

The present example demonstrates the chemical resistance of exemplary composite membranes in solutions of Standard Clean 1, 96 wt % sulfuric acid, or hot sulfuric acid. Chemical resistance of composite membranes were evaluated by measuring stability of certain membrane properties, for example DIW Flow Time and bubble point measured by HFE as disclosed herein.

Exemplary composite membranes were prepared as disclosed herein by coating a disclosed polymer onto PTFE membrane sheets. Composite membrane sheets were then soaked in a Standard Clean 1 (“SC1”) solution, a 96 wt % sulfuric acid solution, or a hot sulfuric acid solution for a period of up to 4-weeks. Chemical resistance of the composite membranes were evaluated by quantifying the percent change in the flow times and bubble point as compared to control membranes which were not exposed to any of the solutions of the present example. The results are presented in Tables 8-10. Percent change was calculated as the absolute difference between the soaked membrane and the control value divided by the control value for each of DIW Flow Time and HFE-BP.

TABLE 8
Composite Membrane Stability in SC1

| | DIW Flow | % Change | | |
|---|---|---|---|---|
| | time (FT) | of DIW | HFE-BP | % Change of |
| Condition | (sec/500 ml) | Flow Time | (psi) | HFE-BP |
| Control | 387 | — | 159 | — |
| 1-week | 412 | 6.459948 | 151 | 5.031447 |
| 2-week | 545 | 40.82687 | 152 | 4.402516 |
| 3-week | 407 | 5.167959 | 165 | 3.773585 |
| 4-week | 428 | 10.5943 | 153 | 3.773585 |

TABLE 9
Composite Membrane Stability in 96 wt % Sulfuric Acid

| Condition | DIW FT (sec/500 mL) | HFE-BP (psi) |
|---|---|---|
| Control | 349 | 61 |
| 1-week | 352 | 60 |
| 4-week | 389 | 70 |

TABLE 10
Composite Membrane Stability in Hot Sulfuric Acid at 70° C.

| Condition | DIW FT (sec/500 ml) | HFE-BP (psi) |
|---|---|---|
| Control | 295 | 126 |
| 1-week | 595 | 158 |

### Aspects

Various Aspects are described below. It is to be understood that any one or more of the features recited in the following Aspect(s) can be combined with any one or more other Aspect(s).

Aspect 1. A porous membrane comprising: a polymer with the following formula:

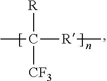

wherein R is an alkyl group, a substituted alkyl group, an aryl group, or a substituted aryl group, and wherein R′ is an alkyl group, a substituted alkyl group, an aryl group, or a substituted aryl group.

Aspect 2. The porous membrane of Aspect 1, wherein an initial bubble point of the porous membrane ranges from 1 psi to 200 psi when measured using ethoxy-nonafluorobutane HFE 7200 at a temperature of about 22° C., and an isopropanol (IPA) flow time of the porous membrane ranges from 10 seconds/500 ml to 19,000 seconds/500 ml when measured at 14.2 psi.

Aspect 3. The porous membrane of Aspect 1 or 2, wherein an initial bubble point of the membrane does not change by more than 20% when measuring the initial bubble point of the membrane before and after soaking the membrane in 96 wt % sulfuric acid for three days, wherein the initial bubble point of the membrane is measured using ethoxy-nonafluorobutane HFE 7200 at a temperature of about 22° C.

Aspect 4. A porous membrane comprising: aromatic fluoropolymer, wherein the membrane has an initial bubble point in a range from 1 to 200 psi when measured using ethoxy-nonafluorobutane HFE 7200 at a temperature of about 22° C. and an IPA flow time in a range from 10 seconds/500 ml to 19,000 seconds/500 ml when measured at 14.2 psi.

Aspect 5. The porous membrane of Aspect 4, wherein an initial bubble point of the membrane does not change by more than 20% when measuring the initial bubble point of the membrane before and after soaking the membrane in 96 wt % sulfuric acid for three days, wherein the initial bubble point of the membrane is measured using ethoxy-nonafluorobutane HFE 7200 at a temperature of about 22° C.

Aspect 6. A porous membrane comprising: aromatic fluoropolymer, wherein an initial bubble point of the membrane does not change by more than 20% when measuring the initial bubble point of the membrane before and after soaking the membrane in 96 wt % sulfuric acid for three days, wherein the initial bubble point of the membrane is measured using ethoxy-nonafluorobutane HFE 7200 at a temperature of about 22° C.

Aspect 7. The porous membrane of any of Aspects 4 to 6, wherein the aromatic fluoropolymers have the following formula:

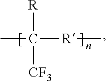

wherein R is an alkyl group, a substituted alkyl group, an aryl group, or a substitute aryl group, and wherein R′ is an alkyl group, a substituted alkyl group, an aryl group, or a substituted aryl group.

Aspect 8. The porous membrane of any of Aspects 1 through 7, wherein, when R is the substituted alkyl group, the substituted alkyl group is a halo alkyl group.

Aspect 9. The porous membrane of any of Aspects 1 through 7, wherein, when R′ is the substituted alkyl group, the substituted alkyl group is a halo alkyl group.

Aspect 10. The porous membrane of any of Aspects 1 through 7, wherein, when R′ is the substituted aryl group, the substituted aryl group is a halo aryl group.

Aspect 11. The porous membrane of any of Aspects 1 through 7, wherein R′ is a biphenyl group.

Aspect 12. The porous membrane of any of Aspects 1 through 7 or 11, wherein the polymer has the following formula:

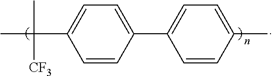

Aspect 13. The porous membrane of any of Aspects 1 through 7 or 11, wherein R is CF₃.

Aspect 14. The porous membrane of Aspect 11, wherein the biphenyl group is substituted with at least one fluoro group.

Aspect 15. The porous membrane of any of Aspects 1 through 7, wherein R is a methyl group.

Aspect 16. The porous membrane of any of Aspects 1 through 7, wherein, when R is the substituted alkyl group or the substituted aryl group, the substituted alkyl group or the substitute aryl group includes at least two substituents.

Aspect 17. The porous membrane of any of Aspects 1 through 7, wherein, when R′ is the substituted alkyl group or the substituted aryl group, the substituted alkyl group or the substituted aryl group includes at least two substituents.

Aspect 18. The porous membrane of any of Aspects 1 through 17, wherein the porous membrane includes a symmetrical porous membrane or an asymmetrical porous membrane.

Aspect 19. The porous membrane of any of Aspects 1 through 18, wherein the polymer does not include a polyaryl ether, a polysulfone, or a polytetrafluoroethane.

Aspect 20. The porous membrane of any of Aspects 1 through 19, wherein the polymer comprises only carbon-carbon bonds in a backbone of the polymer.

Aspect 21. The porous membrane of any of Aspects 1 through 20, wherein the polymer is an aromatic fluoropolymer.

Aspect 22. The porous membrane of any of Aspects 1 through 21, wherein the polymer is a linear aromatic fluoropolymer.

Aspect 23. The porous membrane of any of Aspects 1 through 22, wherein the polymer is linear.

Aspect 24. A method comprising: preparing a porous membrane with a polymer of the formula:

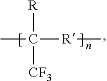

wherein R is an alkyl group, a substituted alkyl group, an aryl group or a substituted aryl group, and wherein R′ is an alkyl group, a substituted alkyl group, an aryl group, or a substituted aryl group.

Aspect 25. The method of Aspect 24, wherein preparing the polymer of the formula comprises adding a first compound to a second compound.

Aspect 26. The method of Aspect 25, wherein the first compound is an activated ketone.

Aspect 27. The method of Aspect 26, wherein the activated ketone comprises a trifluoro acetone or a hexafluoro acetone.

Aspect 28. The method of Aspect 25, wherein the second compound is a hydrocarbon.

Aspect 29. The method of Aspect 28, wherein the hydrocarbon comprises biphenyl.

Aspect 30. The method of Aspect 24, wherein, when R is the substituted alkyl group, the substituted alkyl group is a halo alkyl group.

Aspect 31. The method of Aspect 24, wherein, when R′ is the substituted alkyl group, the substituted alkyl group is a halo alkyl group.

Aspect 32. The method of Aspect 24, wherein, when R′ is the substituted aryl group, the substituted aryl group is a halo aryl group.

Aspect 33. The method of Aspect 24, wherein R′ is a biphenyl group.

Aspect 34, The method of Aspect 33, wherein the polymer has the following formula:

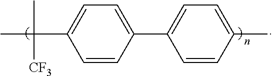

Aspect 35. The method of Aspect 34, wherein R is CF₃.

Aspect 36. The method of Aspect 34, wherein the biphenyl group is substituted with at least one fluoro group.

Aspect 37. The method of Aspect 24, wherein the alkyl group is a methyl group.

Aspect 38. The method of Aspect 24, wherein, when R is the substituted alkyl group or the substituted aryl group, the substituted alkyl group or the substituted aryl group includes at least two substituents.

Aspect 39. The method of Aspect 24, wherein, when R′ is the substituted alkyl group or the substituted aryl group, the substituted alkyl group or the substituted aryl group includes at least two substituents.

Aspect 40. The method of Aspect 24, wherein R′ is a biphenyl group.

Aspect 41. The method of Aspect 24, wherein the porous membrane includes a symmetrical porous membrane or an asymmetrical porous membrane.

Aspect 42. The method of Aspect 24, wherein the polymer does not include a polyaryl ether, a polysulfone, or a polytetrafluoroethane.

Aspect 43. The method of Aspect 24, wherein the polymer comprises only carbon-carbon bonds in backbone of the polymer.

Aspect 44. The method of Aspect 24, wherein the polymer is an aromatic fluoropolymer.

Aspect 45. The method of Aspect 24, wherein the polymer is a linear aromatic fluoropolymer.

Aspect 46. The method of Aspect 24, wherein the polymer is linear.

Aspect 47. A filter comprising the porous membrane of any of Aspects 1 through 23.

Aspect 48. A porous membrane comprising: a polymer comprising one or more monomeric units having a formula of:

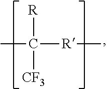

wherein R is a methyl group, an alkyl group, a substituted alkyl group, an aryl group, or a substituted aryl group, and wherein R′ is an alkyl group, a substituted alkyl group, an aryl group, or a substituted aryl group.

Aspect 49. The porous membrane of aspect 48 wherein R is a halogen-substituted alkyl group.

Aspect 50. The porous membrane of aspect 49 wherein the halogen-substituted alkyl group is a fluorine-substituted alkyl group.

Aspect 51. The porous membrane of any of aspects 48-50 wherein R′ is a halogen-substituted aryl group.

Aspect 52. The porous membrane of aspect 51 wherein the halogen-substituted aryl group is a fluorine-substituted aryl group.

Aspect 53. The porous membrane of any of aspects 48-52 wherein R′ is a biphenyl group.

Aspect 54. The porous membrane of aspect 53, wherein the biphenyl group is substituted with at least one fluorine substituent.

Aspect 55. The porous membrane of aspect 53, wherein the polymer comprises a repeat unit having a formula of:

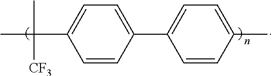

Aspect 56. The porous membrane of aspect 48 wherein the polymer comprises a repeat unit having a formula of:

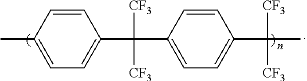

Aspect 57. The porous membrane of any of aspects 48-56, wherein the polymer of the porous membrane does not comprise polyaryl ether, polysulfone, or polytetrafluoroethane.

Aspect 58. The porous membrane of any of aspects 48-57 having: an initial bubble point of the porous membrane in a range from 1 psi to 200 psi when measured using ethoxy-nonafluorobutane HFE 7200 at a temperature of about 22° C.; and an isopropanol (IPA) flow time of the porous membrane ranges from 10 seconds/500 ml to 19,000 seconds/500 ml when measured at 14.2 psi.

Aspect 59. The porous membrane of any of aspects 48-58 characterized as having an absolute difference of no more than about 20% between: (i) an initial bubble point of the porous membrane measured before being placed in a solution for no less than about three days, and (ii) an initial bubble point of the porous membrane measured after being placed in a solution for no less than about three days; wherein the solution is (1) a 96 wt % sulfuric acid solution, (2) a hot sulfuric acid solution, or (3) a SC1 solution; and the initial bubble point for (i) and (ii) is measured using ethoxy-nonafluorobutane HFE 7200 at a temperature of about 22° C.

Aspect 60. A porous membrane comprising an aromatic fluoropolymer, the porous membrane having: an initial bubble point in a range from 1 psi to 200 psi when measured using ethoxy-nonafluorobutane HFE 7200 at a temperature of about 22° C.; and an IPA flow time in a range from 10 seconds/500 ml to 19,000 seconds/500 ml when measured at 14.2 psi.

Aspect 61. The porous membrane of aspect 60 characterized as having an absolute difference of no more than about 20% between: (i) an initial bubble point of the porous membrane measured before being placed in a solution for about three days, and (ii) an initial bubble point of the porous membrane measured after being placed in the solution; wherein the solution is (1) a 96 wt % sulfuric acid solution, (2) a hot sulfuric acid solution, or (3) a SC1 solution; and the initial bubble point for (i) and (ii) is measured using ethoxy-nonafluorobutane HFE 7200 at a temperature of about 22° C.

Aspect 62. A porous membrane comprising an aromatic fluoropolymer, the porous membrane characterized as having an absolute difference of no more than about 20% between: (i) an initial bubble point of the porous membrane measured before being placed in a solution for no less than about three days, and (ii) an initial bubble point of the porous membrane measured after being placed in a solution for no less than about three days; wherein the solution is (1) a 96 wt % sulfuric acid solution, (2) a hot sulfuric acid solution, or (3) a SC1 solution; and the initial bubble point for (i) and (ii) is measured using ethoxy-nonafluorobutane HFE 7200 at a temperature of about 22° C.

Aspect 63. The porous membrane any of aspects 48-62, wherein the porous membrane has a thickness of about 30 μm to about 200 μm.

Aspect 64. The porous membrane of aspect 63, wherein the porous membrane has a thickness of about 50 μm to about 100 μm.

Aspect 65. The porous membrane of aspect 64, wherein the porous membrane has a thickness of about 75 μm.

Aspect 66. A composite membrane comprising a porous membrane of any of aspects 48-66 and a porous polymeric substrate support.

Aspect 67. The composite membrane of aspect 66, wherein the second

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1. A porous membrane comprising:
a polymer comprising one or more monomeric units having a formula of: 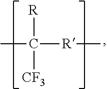
wherein R is a methyl group, an alkyl group, a substituted alkyl group, an aryl group, or a substituted aryl group, and
wherein R′ is an alkyl group, a substituted alkyl group, an aryl group, or a substituted aryl group.

2. The porous membrane of claim 1 wherein R is a halogen-substituted alkyl group.

3. The porous membrane of claim 2 wherein the halogen-substituted alkyl group is a fluorine-substituted alkyl group.

4. The porous membrane of claim 1 wherein R′ is a halogen-substituted aryl group.

5. The porous membrane of claim 4 wherein the halogen-substituted aryl group is a fluorine-substituted aryl group.

6. The porous membrane of claim 1 wherein R′ is a biphenyl group.

7. The porous membrane of claim 6, wherein the biphenyl group is substituted with at least one fluorine substituent.

8. The porous membrane of claim 6, wherein the polymer comprises a repeat unit having a formula of:

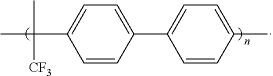

9. The porous membrane of claim 1 wherein the polymer comprises a repeat unit having a formula of:

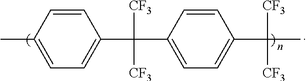

10. The porous membrane of claim 1, wherein the polymer of the porous membrane does not comprise polyaryl ether, polysulfone, or polytetrafluoroethane.

11. The porous membrane of claim 1 having:
an initial bubble point of the porous membrane in a range from 1 psi to 200 psi when measured using ethoxy-nonafluorobutane HFE 7200 at a temperature of about 22° C.; and
an isopropanol (IPA) flow time of the porous membrane ranges from 10 seconds/500 ml to 19,000 seconds/500 ml when measured at 14.2 psi.

12. The porous membrane of claim 1 characterized as having an absolute difference of no more than about 20% between:
(i) an initial bubble point of the porous membrane measured before being placed in a solution for no less than about three days, and
(ii) an initial bubble point of the porous membrane measured after being placed in a solution for no less than about three days;
wherein the solution is (1) a 96 wt % sulfuric acid solution, (2) a hot sulfuric acid solution, or (3) a SC1 solution; and
the initial bubble point for (i) and (ii) is measured using ethoxy-nonafluorobutane HFE 7200 at a temperature of about 22° C.

13. A porous membrane comprising an aromatic fluoropolymer, the porous membrane having:
an initial bubble point in a range from 1 psi to 200 psi when measured using ethoxy-nonafluorobutane HFE 7200 at a temperature of about 22° C.; and
an IPA flow time in a range from 10 seconds/500 ml to 19,000 seconds/500 ml when measured at 14.2 psi.

14. The porous membrane of claim 13 characterized as having an absolute difference of no more than about 20% between:
(i) an initial bubble point of the porous membrane measured before being placed in a solution for about three days, and
(ii) an initial bubble point of the porous membrane measured after being placed in the solution;
wherein the solution is (1) a 96 wt % sulfuric acid solution, (2) a hot sulfuric acid solution, or (3) a SC1 solution; and
the initial bubble point for (i) and (ii) is measured using ethoxy-nonafluorobutane HFE 7200 at a temperature of about 22° C.

15. A porous membrane comprising an aromatic fluoropolymer, the porous membrane characterized as having an absolute difference of no more than about 20% between:
(i) an initial bubble point of the porous membrane measured before being placed in a solution for no less than about three days, and
(ii) an initial bubble point of the porous membrane measured after being placed in a solution for no less than about three days;
wherein the solution is (1) a 96 wt % sulfuric acid solution, (2) a hot sulfuric acid solution, or (3) a SC1 solution; and
the initial bubble point for (i) and (ii) is measured using ethoxy-nonafluorobutane HFE 7200 at a temperature of about 22° C.
